(19) United States
(12) Patent Application Publication
(10) Pub. No.: US 2002/0050363 A1
(43) Pub. Date: May 2, 2002

(54) Domed end cap

(76) Inventor: Hiroshi Hagiya, Ibaragi (JP)

Correspondence Address: PATRICK M. DWYER PC, 1818 WESTLAKE AVENUE N, SUITE 114, SEATTLE, WA, 98109, US

(21) Appl. No.: 09/960,823

(22) Filed: Sep. 21, 2001

Related U.S. Application Data
(60) Provisional application No. 60/234,440, filed on Sep. 21, 2000.

(51) Int. Cl. A62C 35/00; A62C 37/08

(52) U.S. Cl. 169/16; 169/37; 239/565; 239/209; 239/208

(57) ABSTRACT

An end fitting for a sprinkler system where the fitting defines an internal chamber and the chamber is adapted to have at least one fluid exit out of the chamber. The fluid exit is integral to the fitting. There is an internal dome at an end of the chamber, and the fluid exit is adjacent to the dome, or touching the dome, or within the dome. A sprinkler system having a supply pipe, an end fitting for the pipe, a sprinkler head in fluid communication with the end fitting, and a fitting connection adapted for attaching the fitting to an end of the supply pipe, the fitting defining an internal chamber, the chamber adapted to have a plurality of fluid exits therefrom, each fluid exit integral to the fitting. The fitting also has an internal dome at another end of the chamber opposite the supply pipe.

This application claims priority to U.S. Provisional Application No. 60/234,440 filed Sep. 21, 2000.

### TECHNICAL FIELD

The invention relates to the field of plumbing supplies and sprinkler systems; more particularly, it relates to a domed end cap for terminating sprinkler systems, especially fire sprinklers.

### BACKGROUND OF THE INVENTION

Sprinkler systems in commercial buildings typically consist of an array of pipe branching sufficiently to position sprinkler heads uniformly over a fire hazard area to be covered. There are many pipe length terminations in such an array, and they are often capped with conventional blank ends. See generally U.S. Pat. No. 5,031,755 to Blakely. This kind of pipe length termination typically requires tapping the pipe itself if you want a sprinkler head near the terminus of the pipe. Blakely and also Dole (U.S. Pat. No. 5,642,907), propose alternatives to such pipe tapping.

Typically, such a system will be comprised of pipes having an internal diameter of 1.5″ to 2.5″, that at spaced positions along their length are provided with sprinkler heads that extend perpendicular to the longitudinal axis of the associated pipe. The sprinkler heads can be attached to the associated pipe in any one of a number of manners, such as well known in the art. Threaded saddles can be provided on the pipe for securement of the respective sprinkler heads, the saddles communicating with the pipe interior by means of a bore extending radially of the pipe axis. Alternatively, the fitting for support of the sprinkler head can be brazed, welded or otherwise secured to the pipe, the fitting having a bore communicating with the pipe interior.

Such pipelines of sprinkler systems, of necessity require an end closure for the remote end of the pipe. This can be provided by an end fitting in the form of a cap providing an end closure for the pipe, which has been secured to the pipe in any convenient manner, such as by threading onto the pipe, or, by the use of a segmented pipe coupling in the manner later described.

Rather than to provide a blank end cap it is now well known to eliminate the end cap and to provide an end fitting that itself provides a mounting for the terminal sprinkler head of that pipeline.

Blakely suggests a partial flat walled end cap with an opening in the middle of the wall to provide water to an end tapped sprinkler head.

Dole suggests an end fitting for the water supply pipe in a sprinkler system in the form of a hollow tubular body having an internal cavity which progressively decreases in cross-sectional area from an end of the body attached to the supply pipe to an opposite end of the body in the manner of a convergent nozzle. Dole suggests that this tapered wall end cap enhances the pressure of water available to a sprinkler head attached to the fitting. Dole discloses a downward tapped sprinkler head.

These proposals have various engineering disadvantages not the least of which is water hammer effect and other hydraulic anomalies, and in any event provide only a single sprinkler head attachment site.

### DISCLOSURE OF THE INVENTION

The invention is a domed or internally curved end cap with multiple attachment sites. The internal curvature or inner dome at the distal end of the cap allows for a favorable distribution of pressure vectors inside the end cap so that there is no untoward stress on any point in the cap. The multiple attachment sites allow for attachment of one or more sprinkler heads to the cap at the end of a reach of pipe, together with pressure gauges, draincocks, bleed valves, and the like. This design eliminates water hammer effect, as well as promoting adequate and even water flow through sprinkler heads tapped into the end cap. Optionally, system pressure gauges may variously be installed on these end caps, as well as system draincocks or bleed valves.

In preferred embodiments, the end cap is used in combination with any suitable split-sleeve coupling, such as the so called “victaulic” pipe coupling, wherein the pipe is grooved circumferentially adjacent the end, to receive the coupling sleeve in secured sealing relation. An example of a suitable victaulic coupling can be seen in U.S. Pat. No. 3,362,730 (St. Clair et. al.), January 1968 or in U.S. Pat. No. 4,391,458 (Blakeley) July 1983. The proximal end of the end cap presents an end portion which is diametrically and axially sized to the coupling sleeve.

Rather than use a blank end cap, Blakely proposes, as is illustrated FIG. 3 a radially extending annular cap, the central opening of which communicates with an outlet pipe extends arcuately in a 90.degree angle, the pipe terminating in an internally threaded end collar within which the threaded shank of a sprinkler head is secured.

Typically, the outlets of such end fittings must have a bore of at least 0.5″ in order to provide adequate water flow to the sprinkler head. This requires that the radius of curvature of the outlet pipe extending from the end flange of the end fitting must be on a radius of curvature at least equal to the radius of the pipe.

The end fitting, however, is not nearly as robust as the pipe itself. Thus, impact on the end fitting during assembly of the sprinkler system can cause bending or breakage of the outlet pipe of the end fitting.

A major disadvantage with such known end fittings is that while the end flange of such fittings must block off a surface area of 4.9 square inches, the outlet pipe itself only presents an outlet opening of 0.20 square inches. Thus, water progressing along the pipe to the sprinkler head, when the sprinkler head is active, encounters a radial end wall, which extends perpendicular to the axis of the pipe, and, which represents a major source of pressure losses, turbulence and eddy currents, this in turn resulting in a loss in the pressure of fluid exiting the central aperture. Further, as the fluid exiting the central aperture, must itself be changed in direction by 90.degrees, further pressure losses are encountered in the outlet pipe to the sprinkler head. Additionally, pressure losses are believed to be caused by the contraction loss from the pipe diameter to the central aperture diameter.

By configuring the end fitting to have an annular end flange 40, a first source of pressure loss is present. The water entering the internal passage 46 is then subjected to a second pressure loss resulting from the change in direction of the water flow, accompanied by frictional skin effects and further turbulence and eddy currents as the exiting water flow passes through the right-angled elbow 44.

Thus water pressure available to the sprinkler head is lower than that available at other sprinkler heads along the line, which generally results in a lower output volume and reduced spray pattern as compared with other sprinkler heads along the line.

Dole proposes an end fitting for a pipeline of a sprinkler system preferably is configured as a hollow frustum of a cone having a radially extending end flange, and a closure at the smaller end of the frustum (FIGS. 4 & 5).

The frustum itself is not completely circular, except at the end flange adjoining the supply pipe, but includes a flat surface that extends substantially parallel to the pipe axis when the end fitting is installed on a pipe end, supposedly to provide a planar surface on which a sprinkler head can be seated, with a threaded bore extending through the planar surface to permit threading of a sprinkler into the fitting.

Dole maintains that the advantages of this construction are that firstly the flow of water passing longitudinally through the pipe and through the sprinkler head does not meet with an abrupt end face of the end fitting, but instead is directed into a sprinkler bore well ahead of the end of the fitting in a relatively quiescent manner that significantly reduces eddy currents and turbulence.

Dole maintains that the water entering the end fitting passes interiorly into the frustum from the larger to the smaller diameter end thereof in the substantial absence of pressure losses due to contraction. He notes that while this has the effect of retarding the volume per unit time of water flow, it also has the effect of increasing the dynamic pressure in the water flow as it proceeds from the larger diameter end of the frustum towards the smaller diameter end thereof.

He further claims that eddy currents and turbulence are thus suppressed, while at the same time the dynamic pressure of the water flow is increased as it passes through the frustum from the larger end thereof to the smaller end thereof, the pressure increase acting to compensate for the pressure losses that have occurred in the end fitting as a consequence of surface friction, residual eddy currents and turbulence.

To improve on the state of the art, an end fitting for a sprinkler system where the fitting defines an internal chamber and the chamber is adapted to have at least one fluid exit out of the chamber is disclosed. The fluid exit is preferably integral to the fitting, and the chamber has an internal dome at its end. The fluid exit is preferably proximate to the dome; that is, adjacent to the dome, or touching the dome, or within the dome. Also disclosed is a sprinkler system having a supply pipe, an end fitting for the pipe, a sprinkler head in fluid communication with the end fitting, and a fitting connection adapted for attaching the fitting to an end of the supply pipe, the fitting defining an internal chamber, the chamber adapted to have a plurality of fluid exits therefrom, each fluid exit integral to the fitting. The fitting also has an internal dome at another end of the chamber opposite the supply pipe.

In one embodiment an end fitting for a sprinkler system is disclosed. The fitting defines an internal chamber, and the chamber is adapted to have at least one fluid exit. The fluid exit is preferably integral to the fitting. The fitting desirably has a fitting connection at one end of the chamber adapted for attaching the fitting to an end of a supply pipe. The fitting also has an internal dome at another end of the chamber opposite the fitting connection.

Preferably the fluid exit is proximate the dome, which is to say that the fluid exit is adjacent to the dome, or touching the dome, or within the dome. However, it will be appreciated by those skilled in the art, that the fitting and chamber may be desirably elongated, and the fluid exits therefrom set at some distance from the dome, so that the exits are not proximate or in any way adjacent the dome, without departing from the scope of the invention.

The end fitting preferably also has at least one additional fluid exit from the chamber, and has at least one fluid tap boss on an exterior side of the fitting and proximate an exterior of the dome corresponding to each of the fluid exits from the chamber.

There is preferably at least one sprinkler head in fluid communication with one fluid exit from the chamber and, in fluid .communication with another fluid exit from the chamber, one or more devices such as a pressure gauge, bleed valve, drain cock, and/or an additional sprinkler head.

Also disclosed is a sprinkler system comprising a supply pipe, an end fitting for the pipe, a sprinkler head in fluid communication with the end fitting, and a fitting connection adapted for attaching the fitting to an end of the supply pipe, the fitting defining an internal chamber, the chamber adapted to have a plurality of fluid exits therefrom, each fluid exit integral to the fitting, the fitting further comprising an internal dome at another end of the chamber opposite the supply pipe. The sprinkler system preferably also has at least one device such as a pressure gauge, bleed valve, drain cock, and/or an additional sprinkler head, with the device also in fluid communication with the chamber through one of the fluid exits.

The disclosed fitting and its internal chamber preferably has no end wall, or at least not a flat end wall. If the preferred dome at the end of the chamber, can be considered an end wall, then it is decidedly not flat, but curved. In addition, in further distinction to the apparatus proposed by Dole, at least one fluid exit passes through a curved wall, either through or adjacent the dome, not through a flat wall as disclosed by Dole. The preferred tap bosses disclosed can either be drilled and tapped at a factory site, or on the job site. The preferred end fitting can be end tapped, through the dome, as well as tapped from top or bottom or side of the dome.

### BRIEF DESCRIPTION OF THE DRAWINGS

FIG. 1 is a partial cut away elevation of an embodiment of the prior art.

FIG. 2 is a partial cut away elevation of an embodiment of the prior art.

FIG. 3 is a partial cut away elevation of an embodiment of the prior art.

FIG. 4 is a sectional elevation of another embodiment of the prior art.

FIG. 5 is an end view into the fitting shown in FIG. 4.

FIG. 6 is an elevation of an embodiment of the invention.

FIG. 7 is a section view of FIG. 6.

FIG. 8 is a cross section taken along line 8-8 in FIG. 7.

FIG. 9 is an elevation of an alternate embodiment of the invention.

FIG. 10 is a side elevation of an embodiment of the invention in combination with supply pipe and sprinkler.

### BEST MODE OF CARRYING OUT THE INVENTION

FIGS. 1, 2, 3, 4 and 5 are Prior Art. Embodiments of the respective arrangements 10, 12, 14 and 50 comprise a water supply pipe 16 having (in FIGS. 1 & 2) an upwardly extending outlet 18 secured by a peripheral weld 20, in substantially centered, sealed relation with bore 21 in the wall of pipe 16.

In FIG. 2 a closure plug 30 is secured by way of a split victaulic coupling 32, such as generally embodied in U.S. Pat. No. 4,391,458 (Blakeley) July 1983, for which the pipe 16 and closure plug 30 are grooved at 33 and 35 respectively. An axially split peripheral gasket 36 is located in compressed, peripheral sealing relation with the respective outer peripheries of pipe 16, and closure plug 30, to form a leak-tight seal. In FIG. 1 a threaded closure cap 22 makes sealed threaded engagement at 24 with the threaded exterior end of pipe 16.

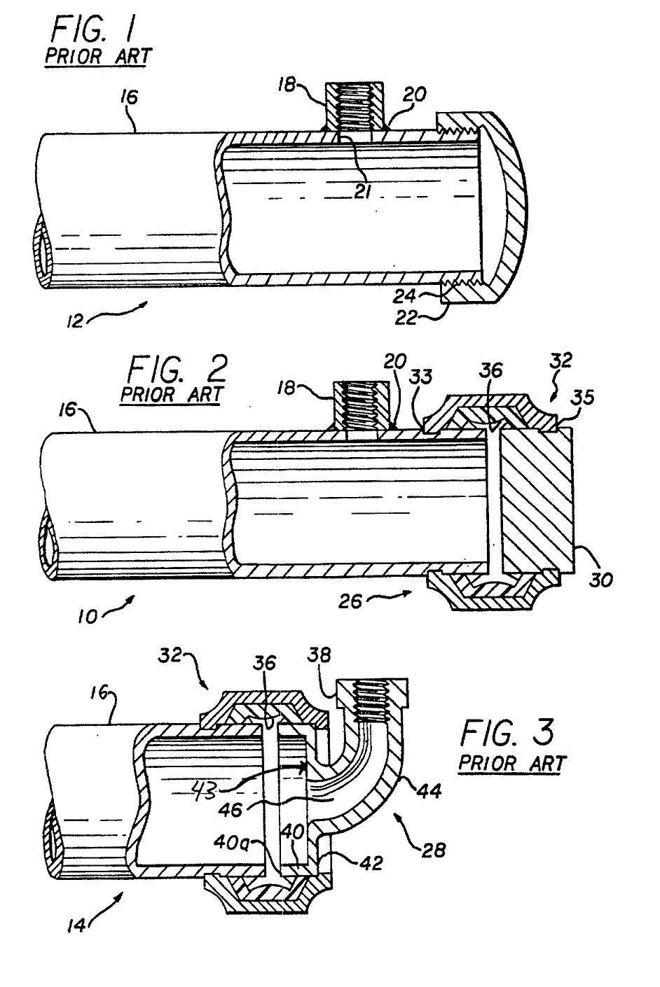

In FIG. 3 the combination 14 comprises a pipe 16, and terminal outlet fitting 28 has a cylindrical proximal end portion 40 with a peripheral shoulder portion 42 for engagement by a split-sleeve coupling 32. The shoulder portion 42 is generally parallel to the end face 40a of the proximal end portion 40. The outlet fitting 28 has a transition passage portion 44 connecting with the internally threaded outlet 38. A sprinkler head (not shown) is screwed in a conventional manner into outlet 38. The passage portion 44 is smoothly curved to and is also provided with a radiused inlet 46 in flat end wall 43.

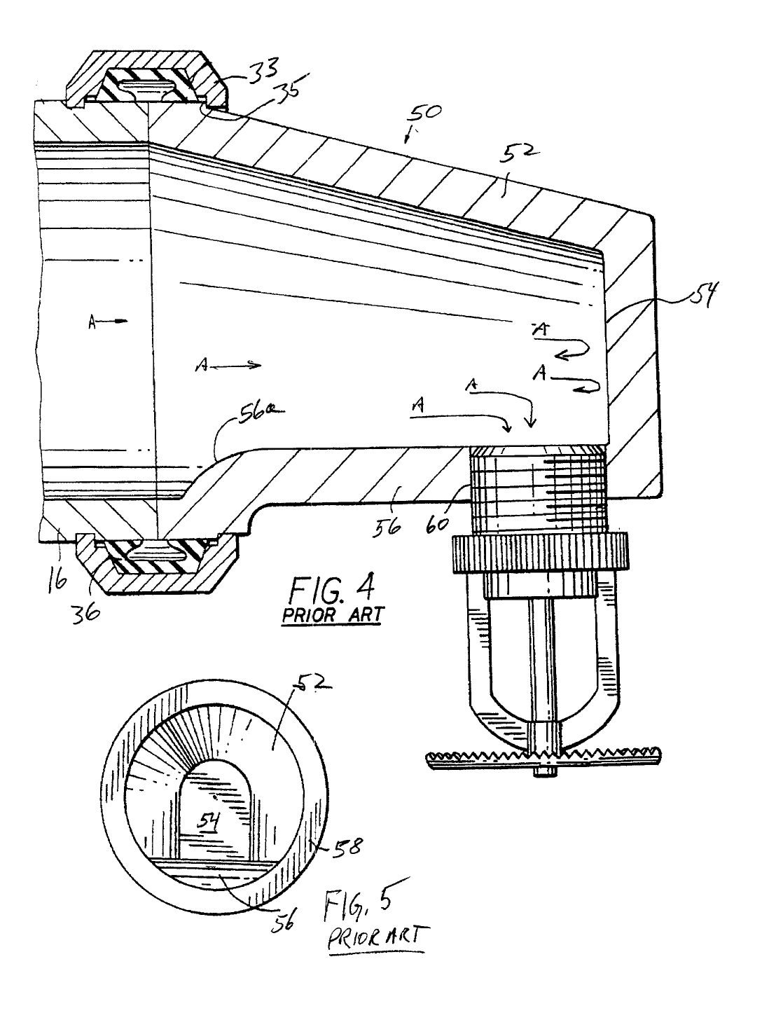

In FIGS. 4 and 5 Dole's end fitting 50 is in the form of a frustum of a cone, the larger end of which is attached to the pipe 16 by use of a segmented pipe coupling 33, the end fitting comprising an arched side wall 52, and a flat rectilinear side wall 56, that terminates in a flat end wall 54. The side walls 52 and 56 begin in an annular end wall 58 that abuts the end of the pipe 16.

However disturbances caused in water flow by Blakely's annular flange 40 and end wall 43 are not eliminated in their entirety by Dole's design. Dole's frustum design still has a flat end wall 54, and while some of the water flow in the fitting moves generally in the direction of straight arrows A, other flow moves in the direction of curved arrows A, especially at the sprinkler exit 60, and most certainly at the end wall 54, thus engendering a significant turbulence yet.

Turning now to the remaining drawings, the invention will be described in a preferred embodiment by reference to the numerals of the drawing figures wherein like numbers indicate like parts.

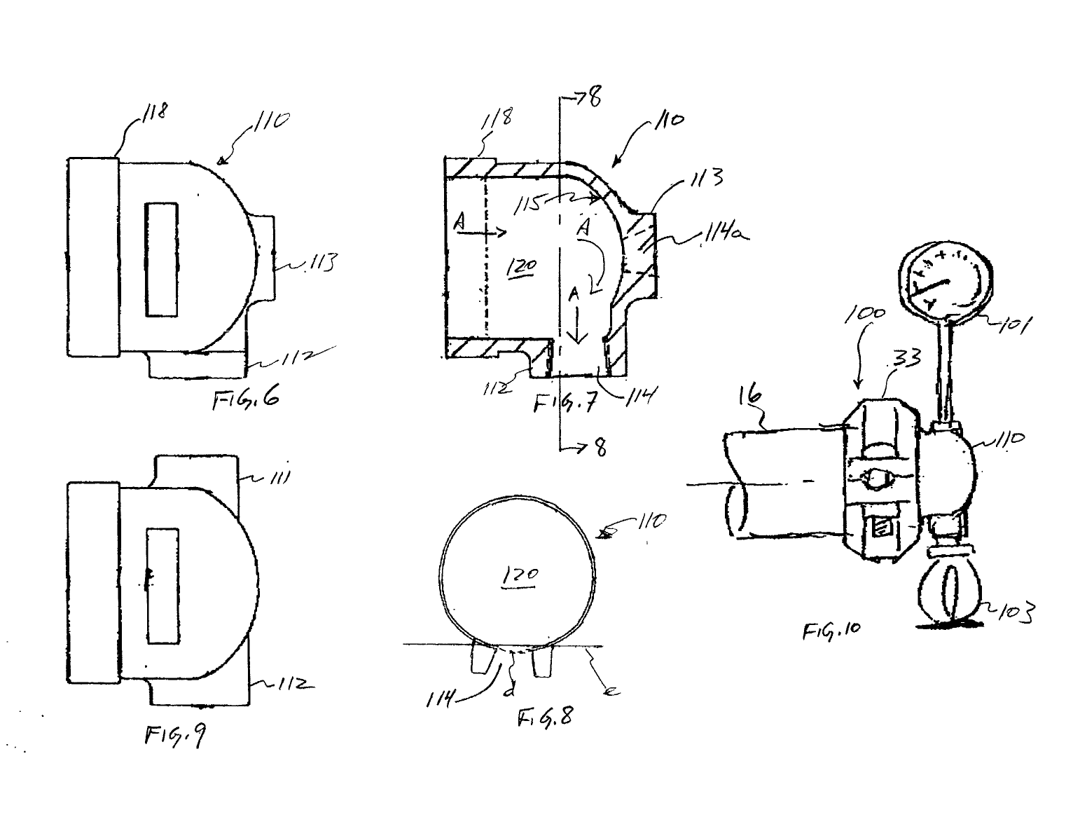

FIGS. 6-9 illustrate alternate preferred embodiments of end fitting (or end cap) 110. End fitting 110 has a coupling shoulder 118 for use with a conventional victaulic coupler to attach cap 110 to a supply pipe (not shown). In FIG. 6, end fitting 110 has two tap bosses 113 and 112, both located on the exterior of dome 115 (see FIG. 7). An alternate embodiment shown in FIG. 9 also has two tap bosses 111 and 112, both also located on the exterior of dome 115, but in different locations, illustrating the flexibility with which tap locations on the dome may be laid out and manufactured.

In FIG. 7, end fitting 110 defines within itself chamber 120, and at an end chamber 120 opposite coupling attachment shoulder 118 is chamber dome 115. Fluid exit 114 is illustratively shown passing through tap boss 112 and proximate dome 115. Dotted lines also show alternate fluid exit 114a passing though center of dome 115 and tap boss 113. Curved flow lines A indicate relatively less turbulent flow of fluid, resulting from flow that does not have to encounter a flat wall, but rather a curved wall or dome 115. Flow lines A lead relatively gently, or moderately, into fluid exit 114, as opposed to the relatively sharply curved lines of FIG. 4 off of flat end wall 54.

In FIG. 8, which is a cross section of FIG. 7 taken at fluid exit 114, it may be seen that fluid exit 114 passes through a curved section of end fitting 110 and chamber 120, not through a flat wall such as is taught by Dole and illustrated in FIGS. 4 and 5 by flat wall 56. Straight reference line e compares where such an exit would be if the wall were flat, while curved reference line d shows the curvature of the wall of fitting 110 actual passed through in the preferred embodiment. It is thus illustrated that such a flat wall exit is not deemed particularly necessary or worthwhile in the preferred embodiment.

FIG. 10 illustrates a preferred aspect of a sprinkler system embodiment. Supply pipe 16 is connected to end cap or end fitting 110 with conventional victaulic coupler 33. Sprinkler head 103 and auxiliary device (pressure gauge, bleed valve, drain cock, or additional sprinkler head) 101 are each tapped into end cap 110 for fluid communication with chamber 120 (not shown). Chamber 120 has at least two fluid exits, and each fluid exit is integral to end cap 110.

Reference has been made in the description to the use of segmented pipe couplings for use in securing the end fitting to the end of the supply pipe. It will be appreciated that alternative manners of attachment can be used advantageously, for example, the threading of the pipe end and the provision of a correspondingly threaded bore at the entrance end of the end fitting, without departing from the scope of the invention.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. An end fitting for a sprinkler system, the fitting defining an internal chamber, the chamber adapted to have at least one fluid exit therefrom, the fluid exit integral to the fitting, the fitting comprising:
a) a fitting connection at one end of the chamber adapted for attaching the fitting to an end of a supply pipe;
b) an internal dome at another end of the chamber opposite the fitting connection.

2. The end fitting of claim 1, wherein the at least one fluid exit is proximate the dome.

3. The end fitting of claim 2, wherein the at least one fluid exit is adjacent to the dome, or touching the dome, or within the dome.

4. The end fitting of claim 1, further adapted to have at least one additional fluid exit from the chamber.

5. The end fitting of claim 1, further comprising at least one fluid tap boss on an exterior side of the fitting and proximate an exterior of the dome.

6. The end fitting of claim 4, further comprising at least one sprinkler head in fluid communication with one fluid exit from the chamber and, in fluid communication with another fluid exit from the chamber, a device from the group consisting of pressure gauge, bleed valve, drain cock, and additional sprinkler head.

7. A sprinkler system comprising a supply pipe, an end fitting for the pipe, a sprinkler head in fluid communication with the end fitting, and a fitting connection adapted for attaching the fitting to an end of the supply pipe, the fitting defining an internal chamber, the chamber adapted to have a plurality of fluid exits therefrom, each fluid exit integral to the fitting, the fitting further comprising an internal dome at another end of the chamber opposite the supply pipe.

8. The sprinkler system of claim 7 further comprising a device from the group consisting of pressure gauge, bleed valve, drain cock, and additional sprinkler head, the device also in fluid communication with the chamber through a fluid exit therefrom.
